(19) United States
(12) Patent Application Publication
(10) Pub. No.: US 2025/0261070 A1
(43) Pub. Date: Aug. 14, 2025

(54) METHODS AND APPARATUSES FOR PARAMETER CONFIGURATION DURING DAPS HANDOVER

(71) Applicant: LENOVO (BEIJING) LIMITED, Beijing (CN)

(72) Inventors: Min XU, Beijing (CN); Ran YUE, Beijing (CN); Jing HAN, Beijing (CN); Lianhai WU, Beijing (CN); Jie HU, Beijing (CN)

(21) Appl. No.: 18/854,825

(22) PCT Filed: Apr. 8, 2022
(86) PCT No.: PCT/CN2022/085840

§ 371 Date: Oct. 7, 2024

(51) Int. Cl. H04W 36/18

(52) U.S. Cl. CPC H04W 36/185

(57) ABSTRACT

The present application relates to methods and apparatuses for a parameter configuration during a dual active protocol stack (DAPS) handover in a non-terrestrial network (NTN) environment. One embodiment of the present disclosure provides a user equipment (UE), comprising: a transceiver; and a processor coupled with the transceiver, and the processor is configured to: receive, with the transceiver, a first set of parameters associated with a target cell for a dual active protocol stack (DAPS) handover; and apply the first set of parameters to the target cell for the DAPS handover.

### TECHNICAL FIELD

The present disclosure generally relates to wireless communication technology, and more particularly to methods and apparatuses for a parameter configuration during a dual active protocol stack (DAPS) handover in a non-terrestrial network (NTN) environment.

### BACKGROUND OF THE INVENTION

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

Until 3^{rd} generation partnership project (3GPP) release 15 for handover, a user equipment (UE) typically releases the connection with a source cell before the connection is established with the target cell (also known as “hard handover”). As a result, the data transmission is stopped at the source cell before the UE starts to communicate with the target cell. This would cause an interruption which is critical for services that are sensitive to latency or continuity. To overcome the above problem, DAPS is introduced wherein the UE maintains the source cell connection after the reception of a handover command, and only releases the source cell connection after a successful access to the target cell (also known as “soft handover”). DAPS can be used to reduce or avoid the service interruption and thus to guarantee service continuity during handover. This requires a UE to simultaneously receive and transmit data at both the source cell and target cell for a short period during the handover procedure.

An NTN refers to a network, or segment of networks, which use radio frequency resources on board a spaceborne vehicle or an airborne vehicle for transmission (e.g., a satellite). For example, the satellite in an NTN can be a geostationary Earth orbiting (GEO) satellite with fixed location to the Earth, or a low Earth orbiting (LEO) satellite orbiting around the Earth.

DAPS may be applied to a wireless communication system with an NTN involved to enhance service continuity. For example, a DAPS procedure may be performed within an NTN with different types of satellites, or performed between an NTN and a terrestrial network (TN).

Compared with a TN, the propagation delay from the UE to the satellite and thus to the base station (which may be on Earth or boarded on a satellite) in an NTN may be much larger. Furthermore, for the NTNs with different types of satellites, the propagation delays may also be different.

Accordingly, it is necessary to provide methods and apparatuses for a parameter configuration during the DAPS handover considering the source BS and the target BS may have different propagation delays.

### SUMMARY

One embodiment of the present disclosure provides a user equipment (UE), comprising: a transceiver; and a processor coupled with the transceiver, and the processor is configured to: receive, with the transceiver, a first set of parameters associated with a target cell for a dual active protocol stack (DAPS) handover; and apply the first set of parameters to the target cell for the DAPS handover.

In some embodiments, the first set of parameters is received in at least one of the following messages: a radio resource control (RRC) reconfiguration message from a first BS that manages a source cell of the UE; or a container message from a second base station (BS) that manages the target cell.

In some embodiments, the first set of parameters includes at least one of the following: one or more values for one or more first timers of the target cell; a round trip time (RTT) value associated with one or more second timers of the target cell; a first common timing advance (TA) of the target cell; a first feeder link delay of the target cell; a first indication associated with downlink hybrid automatic repeat request (HARQ) feedback of the target cell; a second indication associated with uplink HARQ retransmission of the target cell; a cell identity of the target cell; a cell type of the target cell; or a cell platform of the target cell.

In some embodiments, the one or more first timers of the target cell include at least one of the following: a scheduling request (SR) prohibit time; a downlink discontinuous reception (DRX) HARQ round-trip time (RTT) timer; an uplink DRX HARQ RTT timer; a T-Reassembly timer; a discard timer; or a t-Reordering timer.

In some embodiments, the one or more second timers of the target cell include at least one of the following: a contention resolution timer; a downlink DRX HARQ RTT timer; or an uplink DRX HARQ RTT timer.

In some embodiments, applying the first set of parameters to the target cell for the DAPS handover includes at least one of the following: applying the one or more first timers using the one or more values; applying the RTT value as an offset to the second timer; calculating the RTT value based on the first common TA and a first service link delay; calculating the RTT value based on the first feeder link delay and the first service link delay; enabling or disabling downlink HARQ feedback based on the first indication; enabling or disabling the uplink HARQ retransmission based on the second indication; determining the target cell based on the cell identity of the target cell; determining the target cell based on the cell type of the target cell; or determining the target cell based on the cell platform of the target cell.

In some embodiments, the processor is further configured to: in response to a parameter for the target cell being absent in the first set of parameters, determining a corresponding parameter of a source cell as the parameter for the target cell.

In some embodiments, the processor is further configured to: receive, with the transceiver, a second set of parameters associated with a source cell; and apply the second set of parameters to the source cell.

In some embodiments, the second set of parameters is received along with the first set of parameters from a first BS that manages the source cell of the UE, or wherein the second set of parameters is received from a second BS that manages a target cell.

Another embodiment of the present disclosure provides a first BS, comprising: a transceiver; and a processor coupled with the transceiver, and the processor is configured to: receive, with the transceiver and from a second BS, configuration information for a DAPS handover between the first BS and the second BS; and transmit, with the transceiver and to a UE, a first set of parameters associated with a target cell for the DAPS handover, wherein the first set of parameters is determined based on the configuration information.

In some embodiments, the configuration information is received in a handover request message or a handover request acknowledge message.

In some embodiments, the first set of parameters is transmitted in at least one of the following messages: a container message; or a RRC reconfiguration message.

In some embodiments, the first set of parameters includes at least one of the following: one or more values for one or more first timers of the target cell; an RTT value associated with a second timer of the target cell; a first common TA of the target cell; a first feeder link delay of the target cell; a first indication associated with downlink HARQ feedback of the target cell; a second indication associated with uplink HARQ retransmission of the target cell; a cell identity of the target cell; a cell type of the target cell; or a cell platform of the target cell.

In some embodiments, the one or more first timers of the target cell include at least one of the following: an SR prohibit time; a downlink DRX HARQ RTT timer; an uplink DRX HARQ RTT timer; a T-Reassembly timer; a discard timer; or a t-Reordering timer.

In some embodiments, the one or more second timers of the target cell include at least one of the following: a contention resolution timer; a downlink DRX HARQ RTT timer; or an uplink DRX HARQ RTT timer.

In some embodiments, the first BS manages a source cell of the UE, the second BS manages the target cell of the UE, and the configuration information includes the first set of parameters.

In some embodiments, a second set of parameters associated with the source cell is transmitted along with the first set of parameters associated with the target cell.

In some embodiments, the first BS manages the target cell of the UE, the second BS manages a source cell of the UE, and the configuration information includes a second set of parameters associated with the source cell.

In some embodiments, the first set of parameters is generated by: in response to a parameter in the second set of parameters associated with the source cell being not applicable to the target cell, determining a corresponding parameter for the target cell in the first set of parameters; or in response to the parameter associated with the source cell in the configuration information being applicable to the target cell, using the parameter associated with the source cell as the corresponding parameter for the target cell in the first set of parameters or removing the corresponding parameter from the first set of parameters.

Yet another embodiment of the present disclosure provides a method performed by a UE, comprising: receiving a first set of parameters associated with a target cell for a DAPS handover; and applying the first set of parameters to the target cell for the DAPS handover.

Still another embodiment of the present disclosure provides a method performed by a first BS, comprising: receiving, from a second BS, configuration information for a DAPS handover between the first BS and the second BS; and transmitting, to a UE, a first set of parameters associated with a target cell for the DAPS handover, wherein the first set of parameters is determined based on the configuration information.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of a wireless communication system according to some embodiments of the present disclosure.

FIG. 2A illustrates a flow chart of some exemplary DAPS handover procedures according to some embodiments of the present disclosure.

FIG. 2B illustrates another flow chart of some exemplary DAPS handover procedures according to some embodiments of the present disclosure.

FIG. 2C illustrates yet another flow chart of some exemplary DAPS handover procedures according to some embodiments of the present disclosure.

FIG. 3 illustrates a method performed by a UE during a DAPS handover procedure according to some embodiments of the present disclosure.

FIG. 4 illustrates a method performed by a BS during a DAPS handover procedure according to some embodiments of the present disclosure.

FIG. 5 illustrates a simplified block diagram of an exemplary apparatus according to some embodiments of the present disclosure.

### DETAILED DESCRIPTION

The detailed description of the appended drawings is intended as a description of the currently preferred embodiments of the present invention, and is not intended to represent the only form in which the present invention may be practiced. It should be understood that the same or equivalent functions may be accomplished by different embodiments that are intended to be encompassed within the spirit and scope of the present invention.

While operations are depicted in the drawings in a particular order, persons skilled in the art will readily recognize that such operations need not be performed in the particular order as shown or in a sequential order, or that all illustrated operations need be performed, to achieve desirable results; sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present disclosure, examples of which are illustrated in the accompanying drawings. To facilitate understanding, embodiments are provided under specific network architecture and new service scenarios, such as the 3rd generation partnership project (3GPP) 5G (NR), 3GPP long-term evolution (LTE), and so on. It is contemplated that along with the developments of network architectures and new service scenarios, all embodiments in the present disclosure are also applicable to similar technical problems; and moreover, the terminologies recited in the present disclosure may change, which should not affect the principle of the present disclosure.

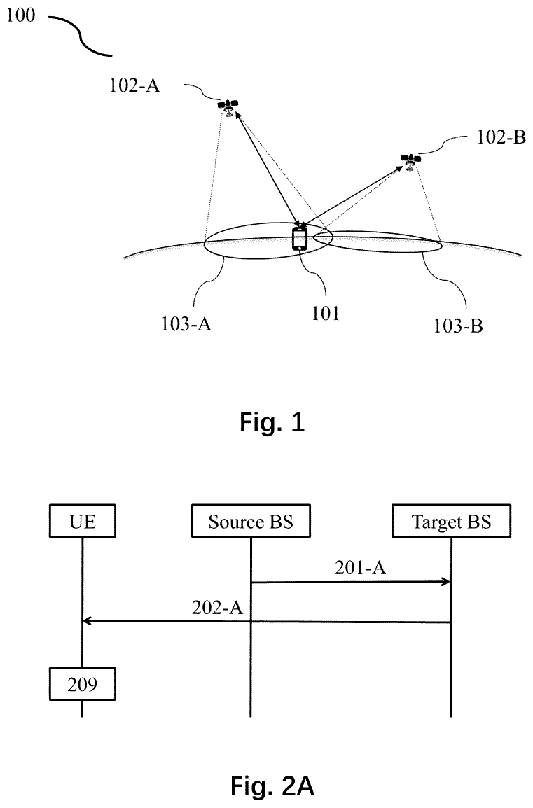

FIG. 1 illustrates a schematic diagram of a wireless communication system 100 in accordance with some embodiments of the present disclosure.

As shown in FIG. 1, wireless communication system 100 may include a UE 101 and some radio access network (RAN) nodes (e.g., satellite 102-A and 102-B). Satellite 102-A may be a GEO satellite, and satellite 102-B may be an LEO satellite orbiting around the Earth.

Although only one UE and two RAN nodes are depicted in FIG. 1, it is contemplated that any number of UEs and RAN nodes may be included in wireless communication system 100. In some embodiments, wireless communication system 100 may also include a TN (not shown in FIG. 1).

In some embodiments, satellite 102-A or satellite 102-B may function as a BS and may include a part or all functions of a BS. In some embodiments, satellite 102-A or satellite 102-B may function as an antenna unit of a BS and the main functionalities of the BS may be located in another entity. For example, a gateway (GW) (not shown in FIG. 1) may function as the BS. Satellite 102-A may provide services within the area 103-A, which may be referred to as the coverage area of the BS. Satellite 102-B may provide services within the area 103-B, which may be referred to as the coverage area of the BS. In some embodiments, other types of network may be included in the communication system 100, such as the TN. For example, a TN BS (not shown in FIG. 1) which provides services within an area may be included.

The UE 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, the UE 101 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present disclosure, the UE 101 includes wearable devices, such as smart watches, fitness bands, optical head-mounted displays, or the like. Moreover, the UE 101 may be referred to as a subscriber unit, a mobile, a mobile station, a user, a terminal, a mobile terminal, a wireless terminal, a fixed terminal, a subscriber station, a user terminal, or a device, or described using other terminology used in the art. The UE 101 may communicate with a BS (e.g., satellite 102-A) via uplink (UL) communication signals. The BS (e.g., satellite 102-A) may communicate with UE 101 via downlink (DL) communication signals.

Wireless communication system 100 may be compatible with any type of network that is capable of sending and receiving wireless communication signals. For example, wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

In some embodiments of the present disclosure, wireless communication system 100 is compatible with 5G NR of the 3GPP protocol. For example, satellite 102-A (or the associated BS) may transmit data using an orthogonal frequency division multiple (OFDM) modulation scheme on the DL and the UE 101 may transmit data on the UL using a discrete Fourier transform-spread-orthogonal frequency division multiplexing (DFT-S-OFDM) or cyclic prefix-OFDM (CP-OFDM) scheme. More generally, however, the wireless communication system 100 may implement other protocols including, for example, some other open or proprietary communication protocols. The present disclosure is not intended to be limited to the implementation of any particular wireless communication system architecture or protocol.

DAPS may be applied to a wireless communication system, for example, a wireless communication system with an NTN involved, such as wireless communication system 100, to enhance service continuity.

To implement the DAPS handover, the source BS may configure the UE with at least one DAPS bearer with radio protocols located in both the source and target cells during the DAPS handover procedure. The UE may check the presence of the field, e.g. daps-Config within the information element (IE), e.g. RadioBearerConfig, to determine whether a DAPS bearer is configured. After the DAPS handover is completed, the UE may release the DAPS bearer if the field daps-SourceRelease is true in RRCReconfiguration message.

For a configured DAPS bearer, the packet data convergence protocol (PDCP) layer is reconfigured to a common PDCP entity for the source and target user plane protocol stacks, to maintain sequence number (SN) continuation and thus in-sequence delivery of user data throughout the DAPS handover procedure. A common re-ordering and duplication function is provided in the single PDCP entity for source and target cells, while ciphering/deciphering and header compression/decompression can be handled separately depending on the origin/destination of the downlink/uplink data packet.

If a DAPS bearer is configured, the UE shall establish a medium access control (MAC) entity, a radio link control (RLC) entity and the logic channels (LCHs) for the target cell with the same configuration as that for the source cell. In other words, the configuration (including configuration of a MAC entity, an RLC entity, and the LCHs) of the source cell and the configuration of those of the target cell are identical.

In some communication systems, different types of networks are included, accordingly, the propagation delays from the UE to the BS may be different. For a TN, the round trip time (RTT) between the UE and the BS may be around 0.033 ms, while for an NTN, the RTT between the UE and the BS may be from 26 ms to 541 ms. For an NTN with GEO deployment, the RTT may be 541 ms, and for an NTN with LEO deployment, the RTT may be from 26 ms to 42 ms.

To address the large propagation delay in an NTN, multiple user plane timers are defined with extended values (for example, e.g. an SR prohibit timer, i.e. sr-ProhibitTimer in MAC entity, a T-Reassembly timer, i.e. T-Reassembly in RLC entity and a discard timer, i.e. DiscardTimer in PDCP entity) to cover one or more RTTs from the UE to the BS. Some other timers are configured with offset values, to cover the RTTs from the UE to the BS (e.g. a contention resolution timer, i.e. ContentionResolutionTimer, a downlink DRX HARQ RTT timer, i.e. drx-HARQ-RTT-TimerDL, and an uplink DRX HARQ RTT timer, i.e. drx-HARQ-RTT-TimerU in MAC entity). Meanwhile, another enhancement to cope with large propagation delay is that the HARQ feedback for downlink transmission and the uplink HARQ retransmission can be disabled by network to avoid buffer overflow and HARQ stalling, which is to be implemented by MAC entity or by LCH configuration.

However, due to the large propagation delay in an NTN, there might be some issues when a DAPS handover procedure takes place between different types of networks (such as the NTN and the TN, or an NTN with one propagation delay and another NTN with another propagation delay), while the same configuration of the source cell and the configuration of the target cell are identical.

Regarding different parameters, the issues are presented as follows:

Issue 1: for the user plane timers that need extended values in an NTN, the values used in the source cell may not be appropriate for the target cell, and vice versa.

For user plane timers that need extended values in an NTN, when a target NTN cell follows a source TN cell configuration and uses the values that is not extended, or when a target NTN GEO cell uses the smaller extended values for a source NTN LEO cell, the timers would expire too early and lead to wrong or unexpected UE behaviors.

For example, if the UE is performing a DAPS handover procedure from a source TN cell to a target NTN cell, the source TN cell may configure the value of PDCP DiscardTimer as 100 ms, and the UE will discard a data packet if no acknowledgement is received when the timer is running. The target NTN cell with RTT larger than 100 ms also uses the same value for the PDCP discard timer, i.e. 100 ms, no acknowledgement will be received within the running period and the UE will discard all data packets. On the other hand, if the UE is performing a DAPS handover procedure from a source NTN cell to a target TN cell, and the target TN cell may also use the values that are extended for the source NTN cell, the timers, for example, the discard timer, would expire too late, and may lead to issues such as buffer overflow without discard. A similar problem also exists in the case that the DAPS handover procedure happens from a source NTN GEO cell to a target NTN LEO cell.

Issue 2: for the user plane timers that need to be offset with the RTT from the UE to the BS, in an NTN, the offset applied in the source cell (or no offset) may not be appropriate for the target cell, and vice versa.

For the user plane timers that need to be offset with the RTT from the UE to the BS, when a target NTN cell follows a source TN cell configuration and does not apply an offset, or when a target NTN GEO cell applies a smaller offset as a source NTN LEO cell, the timers would start and expire too early and lead to error in reception and more power consumption.

In TN, the RTT from the UE to the BS is less than 0.033 ms, in an NTN, the RTT from the UE to the BS ranges from 26 ms to 541 ms. For an NTN with GEO deployment, the RTT may be around 541 ms, and for an NTN with LEO deployment, the RTT may be from 26 ms to 42 ms. When the UE is performing a DAPS handover procedure from a source TN cell to a target NTN cell, the source TN cell does not need to apply an offset to the contention resolution timer, i.e., ContentionResolutionTimer, which may be 50 ms, and there might not be an issue if the timer is started without the RTT offset. For the target NTN cell, it follows the configuration of the source TN cell and does not apply the RTT offset (ranging from 26 ms to 541 ms) to the start of the contention resolution timer, i.e. ContentionResolutionTimer, the timer will be started immediately after transmission while the earliest reception is after one RTT. In this case during the first RTT, the contention resolution timer is running and UE will monitor the corresponding reception, but might be impossible to receive any data. The timer may expire soon after one RTT (or even before one RTT), which may render the actual reception window much smaller (or even no reception window). On the other hand, the UE is performing a DAPS handover procedure from a source NTN cell to a target TN cell, when the target TN cell applies an offset as a source NTN cell, the timers would start and expire too late. A similar problem also exists in the case that the DAPS handover procedure happens from a source NTN GEO cell to a target NTN LEO cell.

Issue 3: regarding the HARQ mode configuration, which includes enabling or disabling downlink HARQ feedback, and enabling or disabling the uplink HARQ retransmission, the HARQ mode configured for LCHs in a source cell may not be supported or workable in a target cell, and vice versa.

For example, when a target NTN cell follows a source TN cell configuration and does not disable it, or when a target NTN GEO cell follows a source NTN LEO cell configuration and does not disable it, buffer overflow or HARQ stalling may occur at the UE or the target cell due to the large propagation delay while downlink HARQ feedback and/or uplink HARQ retransmission is still allowed.

On the other hand, when a target TN cell follows a target TN cell configuration (e.g. disabling the downlink HARQ feedback and disabling the uplink HARQ retransmission), or when a target NTN LEO cell follows a source NTN GEO cell configuration (e.g. disabling the downlink HARQ feedback and disabling the uplink HARQ retransmission), it would be unnecessary considering the much smaller propagation delay and the reliability of transmission and reception may not be guaranteed.

In view of the above, the present disclosure proposes some solutions for the parameter configuration when a DAPS handover procedure is performed between different types of networks.

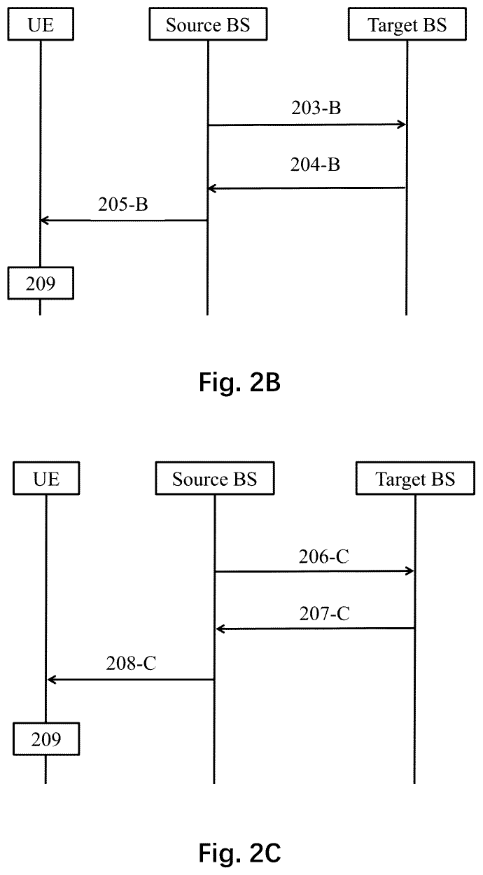

FIG. 2A illustrates a flow chart of some exemplary DAPS handover procedures according to some embodiments of the present disclosure.

In FIG. 2A, three parties are involved, a UE, a source BS, and a target BS. The UE may perform a DAPS handover procedure from the source cell which is managed by the source BS, to the target cell, which is managed by the target BS. The source BS and the target BS may be any type of BSs, for example, a TN BS, an NTN BS such as an NTN BS with a GEO satellite (for example, satellite 102-A in FIG. 1), or an NTN BS with an LEO satellite (for example, satellite 102-B in FIG. 1), or the like.

The flow chart of FIG. 2A includes operation 201-A, operation 202A and operation 209. In operation 201-A, the source BS may transmit the configuration information for a DAPS handover associated with the source cell to the target BS. The configuration information may be included in a container message, for example, the HANDOVER REQUEST message.

The configuration information of the source cell may include at least one of the following timers:
1. an SR prohibit timer of the source cell, i.e. sr-ProhibitTimer;
2. a downlink DRX HARQ RTT timer of the source cell, i.e. drx-HARQ-RTT-TimerDL;
3. an uplink DRX HARQ RTT timer of the source cell, i.e. drx-HARQ-RTT-Timer UL;
4. a T-Reassembly timer of the source cell, i.e. T-Reassembly timer;
5. a discard timer of the source cell, i.e. DiscardTimer; or
6. a t-Reordering timer of the source cell, i.e. t-Reordering timer.

For the discard timer and the t-Reordering timer, the values of these two timers cannot be changed in case of reconfiguration with sync, if the bearer is configured as DAPS bearer.

The configuration information of the source cell may also include an RTT value that may need to be applied as an offset to one or more timers of the source cell, which may include at least one of the following:
1. a contention resolution timer of the source cell, i.e. ContentionResolutionTimer,
2. a DRX HARQ RTT timer of the source cell, i.e. drx-HARQ-RTT-TimerDL; or
3. an uplink DRX HARQ RTT timer of the source cell, i.e. drx-HARQ-RTT-Timer UL;

The configuration information of the source cell may also include at least one of the following:
1. a first indication associated with downlink HARQ feedback of the source cell, e.g. downlinkHARQ-FeedbackDisabled; or
2. a second indication associated with uplink HARQ retransmission of the source cell, e.g. allowedHARQ-mode.

In FIG. 2A, after receiving the configuration information, the target BS may determine the first set of parameters associated with a target cell for the DAPS handover based on the configuration information, and transmit the first set of parameters associated with the target cell for the DAPS handover to the UE. Specifically, the first set of parameters associated with a target cell is transmitted via the inter-BS interfaces between the source BS that manages the source cell and the target BS that manages the target BS, and air interfaces between the UE and source BS, in a container message, for example, HANDOVER REQUEST ACKNOWLEDGE container message, which is transparent to the source BS.

Hereinafter in the present disclosure, the first set of parameters of the target cell may include at least one of the following:
1. one or more values for one or more first timers of the target cell, for example, the following timers may be considered as a first timer:
   i. an SR prohibit timer of the target cell, i.e. sr-ProhibitTimer;
   ii. a downlink DRX HARQ RTT timer of the target cell, i.e. drx-HARQ-RTT-TimerDL;
   iii. an uplink DRX HARQ RTT timer of the target cell, i.e. drx-HARQ-RTT-TimerUL;
   iv. a T-Reassembly timer of the target cell, i.e. T-Reassembly timer;
   v. a discard timer of the target cell, i.e. DiscardTimer; or
   vi. a t-Reordering timer of the target cell, i.e. t-Reordering timer.
2. an RTT value associated with one or more second timers of the target cell, for example, the following timers may be considered as a second timer:
   i. a contention resolution timer of the target cell;
   ii. a downlink DRX HARQ RTT timer of the target cell; or
   iii. an uplink DRX HARQ RTT timer of the target cell;
3. a first common TA of the target cell;
4. a first feeder link delay of the target cell;
5. a first indication associated with downlink HARQ feedback of the target cell; or
6. a second indication associated with uplink HARQ retransmission of the target cell.

In some embodiments, when there are multiple target cells, the first set of parameters of the target cell may further include at least one of the following:
i. a cell identity of the target cell;
ii. a cell type of the target cell, for example, the cell type may include TN or NTN, or the like; or
iii. a cell platform of the target cell, for example, the cell type may include LEO, GEO, or the like.

In operation 209, the UE may apply the first set of parameters of the target cell for performing handover. In some embodiments, the target BS may perform operation 202-A by sending a complete set of parameters including all necessary parameters for the UE to perform the DAPS handover. In some other embodiments, the target BS may perform operation 202-A by sending only a subset of parameters, which only includes the parameters that are necessary and also are different from the corresponding parameters of the source cell to the UE. In this case, the UE may apply the subset of parameters; regarding the other parameters, the UE may use the corresponding parameters of the source cell.

FIG. 2B illustrates another flow chart of some exemplary DAPS handover procedures according to some embodiments of the present disclosure.

In FIG. 2B, the flow chart includes operation 203-B, operation 204-B, operation 205-B and operation 209. In operation 203-B, the source BS may transmit a HANDOVER REQUEST message to the target BS, which requests necessary information from the target BS. In operation 204-B, the target BS may transmit the HANDOVER REQUEST ACKNOWLEDGEMENT message, which includes the configuration information of the target cell from the target BS.

The configuration information of the target cell is similar to that of the source cell, and may include at least one of the following timers:
1. an SR prohibit timer of the target cell, i.e. sr-ProhibitTimer;
2. a downlink DRX HARQ RTT timer of the target cell, i.e. drx-HARQ-RTT-TimerDL;
3. an uplink DRX HARQ RTT timer of the target cell, i.e. drx-HARQ-RTT-Timer UL;
4. a T-Reassembly timer of the target cell, i.e. T-Reassembly timer;
5. a discard timer of the target cell, i.e. DiscardTimer; or
6. a t-Reordering timer of the target cell, i.e. t-Reordering timer.

For the discard timer and the t-Reordering timer, the values of these two timers cannot be changed in case of reconfiguration with sync, if the bearer is configured as DAPS bearer.

The configuration information of the target cell may also include an RTT value that may need to be applied as an offset to one or more timers in a target cell associated with of the target cell, which may include at least one of the following:
1. a contention resolution timer of the target cell, i.e. ContentionResolutionTimer,
2. a DRX HARQ RTT timer of the target cell, i.e. drx-HARQ-RTT-TimerDL; or
3. an uplink DRX HARQ RTT timer of the target cell, i.e. drx-HARQ-RTT-Timer UL;

The configuration information of the target cell may also include at least one of the following:
1. a first indication associated with downlink HARQ feedback of the target cell; or
2. a second indication associated with uplink HARQ retransmission of the target cell.

Based on the configuration information of the target cell, the source BS may determine the first set of parameters of the target cell, which is similar to the first set of parameters of the target cell in embodiments of FIG. 2A. In operation 205-B, the source BS may transmit the first set of parameters to the UE in dedicated signalling, for example, the RRC reconfiguration message. Then, the UE may apply the received first set of parameters of the target cell for performing handover in operation 209.

FIG. 2C illustrates yet another flow chart of some exemplary DAPS handover procedures according to some embodiments of the present disclosure.

The flow chart of FIG. 2C includes operation 206-C, operation 207-C, operation 208-C, and operation 209. Operation 206-C and operation 207-C are similar to operation 203-B and operation 204-B, and details are omitted here.

After receiving the configuration information from the target BS, the source BS may determine the first set of parameters for the target cell and the second set of parameters for the source cell based on the configuration information, and in operation 208-C, the source BS may transmit both the first set of parameters for target cell and the second set of parameters for the source cell to the UE in dedicated signalling, for example, the RRC reconfiguration message.

The second set of parameters for the source cell may include at least one of the following timers:
1. an SR prohibit timer of the source cell, i.e. sr-ProhibitTimer;
2. a downlink DRX HARQ RTT timer of the source cell, i.e. drx-HARQ-RTT-TimerDL;
3. an uplink DRX HARQ RTT timer of the source cell, i.e. drx-HARQ-RTT-Timer UL;
4. a T-Reassembly timer of the source cell, i.e. T-Reassembly timer;
5. a discard timer of the source cell, i.e. DiscardTimer; or
6. a t-Reordering timer of the source cell, i.e. t-Reordering timer.

For the discard timer and the t-Reordering timer, the values of these two timers cannot be changed in case of reconfiguration with sync, if the bearer is configured as DAPS bearer.

The second set of parameters for the source cell may also include an RTT value that may need to be applied as an offset to one or more timers in a source cell associated with of the source cell, which may include at least one of the following:
1. a contention resolution timer of the source cell, i.e. ContentionResolutionTimer,
2. a DRX HARQ RTT timer of the source cell, i.e. drx-HARQ-RTT-TimerDL; or
3. an uplink DRX HARQ RTT timer of the source cell, i.e. drx-HARQ-RTT-Timer UL;

The second set of parameters for the source cell may also include at least one of the following:
1. a first indication associated with downlink HARQ feedback of the source cell; or
2. a second indication associated with uplink HARQ retransmission of the source cell.

The first set of parameters for the target cell is similar to the first set of parameters for the target cell as shown in the embodiments of FIGS. 2A and 2B, and the details are omitted here. Upon receipt of the first set of parameters for target cell and the second set of parameters for the source cell, the UE may perform handover in operation 209.

In the embodiments of FIGS. 2B and 2C, the source BS may send a complete set of parameters of the target cell for the UE to perform the DAPS handover. In some other embodiments, the source BS may send only a subset of the first set of parameters, which only includes the parameters that different from the corresponding parameters of the source cell to the UE, and the UE may apply the subset of parameters, regarding the parameters that are not present in the first set of parameters of the target cell, the UE may use the corresponding parameters of the source cell.

It should be noted that although FIGS. 2A and 2B do not depict the step of the UE receiving the second set of parameters of the source cell, however, persons skilled in the art are aware that the UE shall receive the second set of parameters of the source cell in a DAPS handover procedure. In the case that some parameters are not present in the first set of parameters of the target cell, the UE may use the corresponding value of the parameter of the source cell.

For the embodiments of FIGS. 2A-2C, in operation 209, the UE may apply the first set of parameters of the target cell. Specifically, for the first set of parameters of the target cell, the UE may apply the values of at least one of the following timers:
1. an SR prohibit timer of the target cell, i.e. sr-ProhibitTimer;
2. a downlink DRX HARQ RTT timer of the target cell, i.e. drx-HARQ-RTT-TimerDL;
3. an uplink DRX HARQ RTT timer of the target cell, i.e. drx-HARQ-RTT-Timer UL;
4. a T-Reassembly timer of the target cell, i.e. T-Reassembly timer;
5. a discard timer of the target cell, i.e. DiscardTimer; or
6. a t-Reordering timer of the target cell, i.e. t-Reordering timer.

Regarding the above timers, at least the following three cases may be considered:

Case Ta): the source cell is a TN cell, and the target cell is an NTN cell. In case Ta), the above timers of the target cell are extended, i.e. the timers are with an extended value. Each timer may have a different an extended value. The UE may apply at least one of the above timers with an extended value to the target cell.

Case Tb): the source cell is an NTN cell, and the target cell is a TN cell. In case Tb), the above timers of the target cell are not extended, i.e. the timers are without an extended value. The UE may apply at least one of the above timers without an extended value to the target cell.

Case Tc): the source cell is an NTN cell with an LEO satellite, and the target cell is an NTN cell with a GEO satellite; or the source cell is an NTN cell with a GEO satellite, and the target cell is an NTN cell with an LEO satellite. In case Tc), the above timers of the target cell and the above timers of the source cell are both extended, but with different values, i.e. a timer of the target cell is with one extended value, and the corresponding timer of the source cell is with a different extended value. Each timer of the target cell may have a different extended value compared with the corresponding timer of the source cell. The UE may apply at least one of the above timers with an extended value to the target cell, which is a different extended value from that of the source cell.

It should be noted that although only two types of satellites are described in case c), the solutions may also use other types of satellites. If any timer is absent, the UE may use the value of the corresponding timer in the source cell.

The UE may apply the RTT value of the target cell as an offset to at least one of the following timers of the target cell:
1. a contention resolution timer of the target cell, i.e. ContentionResolutionTimer,
2. a DRX HARQ RTT timer of the target cell, i.e. drx-HARQ-RTT-TimerDL; or
3. an uplink DRX HARQ RTT timer, i.e. drx-HARQ-RTT-TimerUL;

If any timer is absent of the target cell, the UE may use the value of the corresponding timer of the source cell. Regarding the above timers, at least the following three cases may be considered:
Case T1): the source cell is a TN cell, and the target cell is an NTN cell. In case T1), the UE may apply the RTT to the start or the duration to at least one of the above three timers.
Case T2): the source cell is an NTN cell, and the target cell is a TN cell. In case T2), the first set of parameters of the target cell may not include the RTT, and the UE may not apply the RTT to the start or the duration to at least one of the above three timers.
Case T3): the source cell is an NTN cell with an LEO satellite, and the target cell is an NTN cell with a GEO satellite; or the source cell is an NTN cell with a GEO satellite, and the target cell is an NTN cell with an LEO satellite. In case T3), the UE may apply the RTT to the start or the duration of the above three timers. In the case that the first set of parameters does not include the RTT, the UE may not apply the RTT as an offset to at least one of the above three timers.

In some other embodiments, the RTT value may not be included in the first set of parameters of the target cell, and the UE may calculate the RTT value based on the common TA or feeder link delay value in the target cell, and use the calculated RTT value to offset the timers.

Specifically, the UE may calculate the RTT of the target cell based on at least one of the following equations:

$$RTT = common TA + 2 \times service link delay of the target cell ; or$$

$$RTT = 2 \times ( feeder link delay of the target cell + service link delay of the target cell ) .$$

Wherein the service link delay of the target cell may be calculated by the UE based on the location of the UE and the satellite ephemeris of the satellite of the target cell.

The UE may further apply the HARQ mode to the target cell, which includes downlink HARQ feedback and/or uplink HARQ retransmission, based on the first indication and the second indication in first set of parameters of the target cell. If the HARQ mode is absent in the first set of parameters of the target cell, the UE may use the same the HARQ mode as the source cell.

In particular, the UE may apply the first indication in the first set of parameters of the target cell by enabling or disabling downlink HARQ feedback based on the first indication. Specifically, the parameter, e.g., downlinkHARQ-FeedbackDisabled, may indicate enabling the downlink HARQ feedback in the target cell, and the UE may enable the downlink HARQ feedback in the target cell, or vice versa.

The UE may further apply the second indication in the first set of parameters of the target cell by enabling or disabling the uplink HARQ retransmission based on the second indication. Specifically, the parameter, e.g., allowedHARQ-mode, may indicate enabling the uplink HARQ retransmission in the target cell, and the UE may enable the uplink HARQ retransmission in the target cell, or vice versa.

Regarding the above indications, at least the following three cases may be considered:
Case TI): the source cell is a TN cell, and the target cell is an NTN cell. In case TI), the UE may apply the indicated HARQ mode.
Case TII): the source cell is an NTN cell, and the target cell is a TN cell. In case TII), no HARQ mode may be indicated, that is, the first indication and the second indication may not be included in the first set of parameters of the target cell, and UE may not apply any HARQ mode to the target cell.
Case TIII): the source cell is an NTN cell with an LEO satellite, and the target cell is an NTN cell with a GEO satellite; or the source cell is an NTN cell with a GEO satellite, and the target cell is an NTN cell with an LEO satellite. In case TIII), UE may apply the indicated HARQ mode, or UE may not apply HARQ mode if the indications are absent in the first set of parameters of the target cell.

In some embodiments, the first set of parameters may include the information of the target cell, such as the cell identity, the cell type, the cell platform as mentioned above. The UE may determine the target cell based on the cell identity, determine a target cell with the same type as indicated by the cell type indication (for example, the cell type may be a TN or an NTN), or determine a target cell with the same platform as indicated by the cell platform indication (for example, the platform may be an LEO or a GEO). In some embodiments, there is only one target cell, and the UE may determine the only target cell as the target cell.

For the embodiments of FIG. 2C, in operation 209, the UE may further apply the second set of parameters of the source cell, in particular the UE may apply at least one of the following timers:
1. an SR prohibit timer of the source cell, i.e. sr-ProhibitTimer;
2. a downlink DRX HARQ RTT timer of the source cell, i.e. drx-HARQ-RTT-TimerDL;
3. an uplink DRX HARQ RTT timer of the source cell, i.e. drx-HARQ-RTT-Timer UL;
4. a T-Reassembly timer of the source cell, i.e. T-Reassembly timer;
5. a discard timer of the source cell, i.e. DiscardTimer, or
6. a t-Reordering timer of the source cell, i.e. t-Reordering timer.

Regarding the above timers, at least the following three cases may be considered:

Case Sa): the source cell is a TN cell, and the target cell is an NTN cell. In case Sa), the above timers of the source cell are not extended, i.e. the timers are without extended value. The UE may apply at least one of the above timers without an extended value to the source cell.

Case Sb): the source cell is an NTN cell, and the target cell is a TN cell. In case Sb), the above timers of the source cell are extended, i.e. the timers are with an extended value. Each timer may have a different extended value. The UE may apply at least one of the above timers with an extended value to the source cell.

Case Sa): the source cell is an NTN cell with an LEO satellite, and the target cell is an NTN cell with a GEO satellite; or the source cell is an NTN cell with a GEO satellite, and the target cell is an NTN cell with an LEO satellite. In case Sc), both the above timers of the target cell and the above timers of the source cell are extended, but with different values, i.e. the timers of the source cell are extended value. Each timer of the source cell may have a different extended value compared with the corresponding timer of the target cell. The UE may apply at least one of the above timers with an extended value to the source cell, which is different extended value from that of the target cell.

It should be noted that although only two types of satellites are described in case c), the solutions may also use other types of satellites. If any timer is absent in the second set of parameters, the UE may use the default value of the corresponding timer.

The UE may apply the RTT value as an offset to at least one of the following timers of the source cell:
1. a contention resolution timer of the source cell, i.e. ContentionResolutionTimer,
2. a DRX HARQ RTT timer of the source cell, i.e. drx-HARQ-RTT-TimerDL; or
3. an uplink DRX HARQ RTT timer of the source cell, i.e. drx-HARQ-RTT-Timer UL;

If any timer is absent, the UE may use the default RTT value. Regarding the above timers, at least the following three cases may be considered:
Case S1): the source cell is a TN cell, and the target cell is an NTN cell. In case S1), the second set of parameters may not include the RTT, and the UE may not apply the RTT to the start or the duration of at least one of the above three timers.
Case S2): the source cell is an NTN cell, and the target cell is a TN cell. In case S2), the UE may apply the RTT to the start or the duration of at least one of the above three timers to the source cell.
Case S3): the source cell is an NTN cell with an LEO satellite, and the target cell is an NTN cell with a GEO satellite; or the source cell is an NTN cell with a GEO satellite, and the target cell is an NTN cell with an LEO satellite. In case S3), the UE may apply the RTT to the start or the duration of the above three timers. In the case that the second set of parameters does not include the RTT, the UE may not apply the RTT as an offset to at least one of the above three timers.

In some other embodiments, the RTT value may not be included in the second set of parameters of the source cell, and the UE may calculate the RTT value based on the common TA or feeder link delay value in the source cell that can be used to calculate the RTT value.

Specifically, the UE may calculate the RTT of the source cell based on at least one of the following equations:

$$RTT = common TA + 2 \times service link delay of the source cell ; or$$

$$RTT = 2 \times ( feeder link delay of the source cell + service link delay of the source cell )$$

Wherein the service link delay of the source cell may be calculated the UE based on the location of the UE and the satellite ephemeris of the satellite of the source cell.

The UE may further apply the HARQ mode to the source cell, which includes downlink HARQ feedback and/or uplink HARQ retransmission, based on the second set of parameters of the source cell. If the HARQ mode is absent, the UE may use the default HARQ mode to the source cell.

In particular, the UE may further apply the first indication in the second set of parameters of the source cell by enabling or disabling downlink HARQ feedback based on the first indication. Specifically, the parameter, e.g., downlinkHARQ-FeedbackDisabled, may indicate enabling the downlink HARQ feedback in the source cell, and the UE may enable the downlink HARQ feedback in the source cell, or vice versa.

The UE may further apply the second indication in the second set of parameters of the source cell by enabling or disabling the uplink HARQ retransmission based on the second indication. Specifically, the parameter, e.g., allowedHARQ-mode, may indicate enabling the uplink HARQ retransmission in the source cell, and the UE may enable the uplink HARQ retransmission in the source cell, or vice versa.

Regarding the above indications, at least the following three cases may be considered:
Case SI): the source cell is a TN cell, and the target cell is an NTN cell. In case SI), the UE may apply the indicated HARQ mode.
Case SII): the source cell is an NTN cell, and the target cell is a TN cell. In case SII), no HARQ mode is indicated, that is, the first indication and the second indication may not be included in the second set of parameters of the source cell, and UE may not apply any HARQ mode to the source cell.
Case SIII): the source cell is an NTN cell with an LEO satellite, and the target cell is an NTN cell with a GEO satellite; or the sources cell is an NTN cell with a GEO satellite, and the target cell is an NTN cell with an LEO satellite. In case SIII), UE may apply the indicated HARQ mode, or UE may not apply HARQ mode or apply the default HARQ mode if the indications are absent in the second set of parameters.

In some embodiments, the second set of parameters may include the information of the source cell, such as the cell identity, the cell type, the cell platform as mentioned above. The UE may determine the source cell based on the cell identity, determine a source cell with the same type as indicated by the cell type indication (for example, the cell type may be a TN or an NTN), or determine a source cell with the same platform as indicated by the cell platform indication (for example, the platform may be an LEO or a GEO). In some embodiments, there is only one source cell, and the UE may determine the only source cell as the source cell.

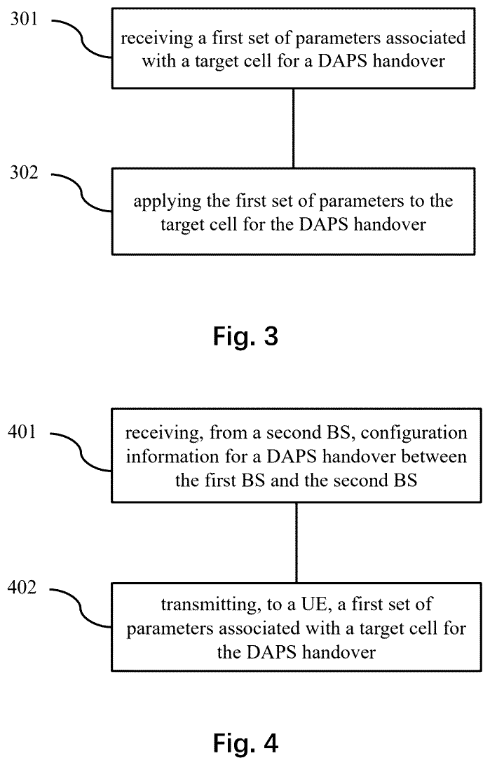

FIG. 3 illustrates a method performed by a UE during a DAPS handover procedure according to some embodiments of the present disclosure.

In operation 301, the UE may receive a first set of parameters associated with a target cell for a DAPS handover; and in operation 302, the UE may apply the first set of parameters to the target cell for the DAPS handover.

In some embodiments, the first set of parameters is received in at least one of the following messages: a RRC reconfiguration message from a first BS that manages a source cell of the UE; or a container message from a second BS that manages the target cell.

In some embodiments, the first set of parameters includes at least one of the following:
one or more values for one or more first timers of the target cell;
an RTT value associated with one or more second timers of the target cell;
a first common TA of the target cell;
a first feeder link delay of the target cell;
a first indication associated with downlink HARQ feedback of the target cell;
a second indication associated with uplink HARQ retransmission of the target cell;
a cell identity of the target cell;
a cell type of the target cell; or
a cell platform of the target cell.

In some embodiments, the one or more first timers of the target cell include at least one of the following:
an SR prohibit time;
a downlink DRX HARQ RTT timer;
an uplink DRX HARQ RTT timer;
a T-Reassembly timer;
a discard timer; or
a t-Reordering timer.

In some embodiments, the one or more second timers of the target cell include at least one of the following:
a contention resolution timer;
a downlink DRX HARQ RTT timer; or
an uplink DRX HARQ RTT timer.

In some embodiments, applying the first set of parameters to the target cell for the DAPS handover includes at least one of the following:
applying the one or more first timers using the one or more values;
applying the RTT value as an offset to the second timer;
calculating the RTT value based on the first common TA and a first service link delay;
calculating the RTT value based on the first feeder link delay and the first service link delay;
enabling or disabling downlink HARQ feedback based on the first indication;
enabling or disabling the uplink HARQ retransmission based on the second indication;
determining the target cell based on the cell identity of the target cell;
determining the target cell based on the cell type of the target cell; or
determining the target cell based on the cell platform of the target cell.

In some embodiments, in response to a parameter for the target cell being absent in the first set of parameters, the UE may determine a corresponding parameter of a source cell as the parameter for the target cell.

In some embodiments, the UE may receive a second set of parameters associated with a source cell; and apply the second set of parameters to the source cell. In some embodiments, the second set of parameters is received along with the first set of parameters from a first BS that manages the source cell of the UE, or wherein the second set of parameters is received from a second BS that manages a target cell. For example, in operation 208-C, the UE receives the second set of parameters associated with a source cell, which is received along with the first set of parameters of the target cell.

FIG. 4 illustrates a method performed by a BS during a DAPS handover procedure according to some embodiments of the present disclosure.

In operation 401, the first BS may receive from a second BS, configuration information for a DAPS handover between the first BS and the second BS; and in operation 402, the first BS may transmit to the UE, a first set of parameters associated with a target cell for the DAPS handover, wherein the first set of parameters is determined based on the configuration information.

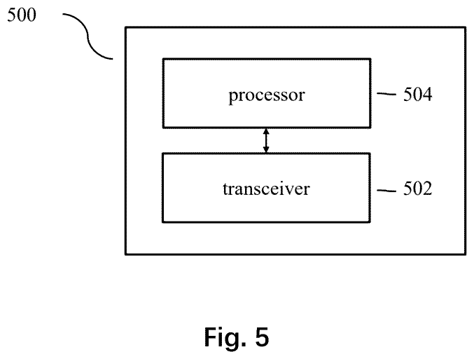

FIG. 5 illustrates a simplified block diagram of an exemplary apparatus according to some embodiments of the present disclosure.

FIG. 5 illustrates a block diagram of an exemplary apparatus 500 according to some embodiments of the present disclosure. As shown in FIG. 5, the apparatus 500 may include at least one processor 504 and at least one transceiver 502 coupled to the processor 504. The apparatus 500 may be a UE or a BS.

Although in this figure, elements such as the at least one transceiver 502 and processor 504 are described in the singular, the plural is contemplated unless a limitation to the singular is explicitly stated. In some embodiments of the present application, the transceiver 502 may be divided into two devices, such as a receiving circuitry and a transmitting circuitry. In some embodiments of the present application, the apparatus 500 may further include an input device, a memory, and/or other components.

In some embodiments of the present application, the apparatus 500 may be a UE. The transceiver 502 and the processor 504 may interact with each other so as to perform the operations with respect to the UE described in FIGS. 1-4. In some embodiments of the present application, the apparatus 500 may be a BS. The transceiver 502 and the processor 504 may interact with each other so as to perform the operations with respect to the BS described in FIGS. 1-4.

In some embodiments of the present application, the apparatus 500 may further include at least one non-transitory computer-readable medium.

For example, in some embodiments of the present disclosure, the non-transitory computer-readable medium may have stored thereon computer-executable instructions to cause the processor 504 to implement the method with respect to the UE as described above. For example, the computer-executable instructions, when executed, cause the processor 504 interacting with transceiver 502 to perform the operations with respect to the UE described in FIGS. 1-4.

In some embodiments of the present disclosure, the non-transitory computer-readable medium may have stored thereon computer-executable instructions to cause the processor 504 to implement the method with respect to the BS as described above. For example, the computer-executable instructions, when executed, cause the processor 504 interacting with transceiver 502 to perform the operations with respect to the BS described in FIGS. 1-4.

The method of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each FIG. are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

In this disclosure, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

1. A user equipment (UE) for wireless communication, comprising:
at least one memory; and
at least one processor coupled with the at least one memory and configured to cause the UE to:
receive a first set of parameters associated with a target cell for a dual active protocol stack (DAPS) handover; and
apply the first set of parameters to the target cell for the DAPS handover.

2. The UE of claim 1, wherein the first set of parameters is received in at least one of the following messages:
a radio resource control (RRC) reconfiguration message from a first base station (BS) that manages a source cell of the UE; or
a container message from a second BS that manages the target cell.

3. The UE of claim 1, wherein the first set of parameters includes at least one of the following:
one or more values for one or more first timers of the target cell-;
a round trip time (RTT) value associated with one or more second timers of the target cell;
a first common timing advance (TA) of the target cell;
a first feeder link delay of the target cell;
a first indication associated with downlink hybrid automatic repeat request (HARQ) feedback of the target cell;
a second indication associated with uplink HARQ retransmission of the target cell;
a cell identity of the target cell;
a cell type of the target cell; or
a cell platform of the target cell.

4. The UE of claim 3, wherein the one or more first timers of the target cell include at least one of the following:
a scheduling request (SR) prohibit time;
a downlink discontinuous reception (DRX) hybrid automatic repeat request (HARQ) round-trip time (RTT) timer;
an uplink DRX HARQ RTT timer;
a T-Reassembly timer;
a discard timer; or
a t-Reordering timer.

5. The UE of claim 3, wherein the one or more second timers of the target cell include at least one of the following:
a contention resolution timer;
a downlink DRX HARQ RTT timer; or
an uplink DRX HARQ RTT timer.

6. The UE of claim 3, wherein applying the first set of parameters to the target cell for the DAPS handover includes at least one of the following:
applying the one or more first timers using the one or more values;
applying the RTT value as an offset to the second timer;
calculating the RTT value based on the first common TA and a first service link delay;
calculating the RTT value based on the first feeder link delay and the first service link delay;
enabling or disabling downlink HARQ feedback based on the first indication;
enabling or disabling the uplink HARQ retransmission based on the second indication;
determining the target cell based on the cell identity of the target cell;
determining the target cell based on the cell type of the target cell; or
determining the target cell based on the cell platform of the target cell.

7. The UE of claim 3, wherein the at least processor is further configured to cause the UE to:
in response to a parameter for the target cell being absent in the first set of parameters, determine a corresponding parameter of a source cell as the parameter for the target cell.

8. The UE of claim 1, wherein the at least one processor is further configured to cause the UE to:
Receive a second set of parameters associated with a source cell; and
apply the second set of parameters to the source cell.

9. The UE of claim 8, wherein the second set of parameters is received along with the first set of parameters from a first base station (BS) that manages the source cell of the UE, or wherein the second set of parameters is received from a second BS that manages a target cell.

10. A first base station (BS), comprising:
at least one memory; and
at least one processor coupled with the at least one memory and configured to cause the first BS to:
receive, from a second BS, configuration information for a dual active protocol stack (DAPS) handover between the first BS and the second BS; and
transmit, to a user equipment (UE), a first set of parameters associated with a target cell for the DAPS handover, wherein the first set of parameters is determined based on the configuration information.

11. The first BS of claim 10, wherein the configuration information is received in a handover request message or a handover request acknowledge message.

12. The first BS of claim 10, wherein the first set of parameters includes at least one of the following:
one or more values for one or more first timers of the target cell;
a round trip time (RTT) value associated with a second timer of the target cell;
a first common timing advance (TA) of the target cell;
a first feeder link delay of the target cell;
a first indication associated with downlink hybrid automatic repeat request (HARQ) feedback of the target cell;
a second indication associated with uplink HARQ retransmission of the target cell;
a cell identity of the target cell;
a cell type of the target cell; or
a cell platform of the target cell.

13. The first BS of claim 12 wherein the one or more first timers of the target cell include at least one of the following:
a scheduling request (SR) prohibit time;
a downlink discontinuous reception (DRX) hybrid automatic repeat request (HARQ) round-trip time (RTT) timer;
an uplink DRX HARQ RTT timer;
a T-Reassembly timer;
a discard timer; or
a t-Reordering timer.

14. The first BS of claim 12, wherein the one or more second timers of the target cell include at least one of the following:
a contention resolution timer;
a downlink DRX HARQ RTT timer; or
an uplink DRX HARQ RTT timer.

15. A method performed by a user equipment (UE), the method comprising:
receiving a first set of parameters associated with a target cell for a dual active protocol stack (DAPS) handover; and
applying the first set of parameters to the target cell for the DAPS handover.

16. A processor for wireless communication, comprising:
at least one controller coupled with the at least one memory and configured to cause the processor to:
receive a first set of parameters associated with a target cell for a dual active protocol stack (DAPS) handover; and
apply the first set of parameters to the target cell for the DAPS handover.

17. The processor of claim 16, wherein the first set of parameters is received in at least one of the following messages:
a radio resource control (RRC) reconfiguration message from a first base station (BS) that manages a source cell of the processor; or
a container message from a second BS that manages the target cell.

18. The processor of claim 16, wherein the first set of parameters includes at least one of the following:
one or more values for one or more first timers of the target cell;
a round trip time (RTT) value associated with one or more second timers of the target cell;
a first common timing advance (TA) of the target cell;
a first feeder link delay of the target cell;
a first indication associated with downlink hybrid automatic repeat request (HARQ) feedback of the target cell;
a second indication associated with uplink HARQ retransmission of the target cell;
a cell identity of the target cell;
a cell type of the target cell; or
a cell platform of the target cell.

19. The processor of claim 18, wherein the one or more first timers of the target cell include at least one of the following:
a scheduling request (SR) prohibit time;
a downlink discontinuous reception (DRX) hybrid automatic repeat request (HARQ) round-trip time (RTT) timer;
an uplink DRX HARQ RTT timer;
a T-Reassembly timer;
a discard timer; or
a t-Reordering timer.

20. The processor of claim 18, wherein the one or more second timers of the target cell include at least one of the following:
a contention resolution timer;
a downlink DRX HARQ RTT timer; or
an uplink DRX HARQ RTT timer.
